(19) United States
(12) Patent Application Publication
(10) Pub. No.: US 2008/0001635 A1
(43) Pub. Date: Jan. 3, 2008

(54) Data Receiving Device and Data Receiving Method

(76) Inventor: Makoto Miyake, Osaka (JP)

Correspondence Address: MCDERMOTT WILL & EMERY LLP, 600 13TH STREET, NW, WASHINGTON, DC, 20005-3096, US

(21) Appl. No.: 11/794,323

(22) PCT Filed: Aug. 26, 2005
(86) PCT No.: PCT/JP05/15567

§ 371 Date: Jun. 28, 2007

(30) Foreign Application Priority Data
Dec. 28, 2004 (JP) 2004-381602

(51) Int. Cl. H04L 25/03

(52) U.S. Cl. 327/54

(57) ABSTRACT

Upon detection of input of an input signal in a signal detector 101 of a data receiving device 100, a receiving circuit 103 starts receiving the input signal. When the signal detector 101 determines the input signal as a data signal, a first logic circuit 104 outputs a receiving signal received at the receiving circuit 103 as a data signal.

### TECHNICAL FIELD

The present invention relates to a data receiving circuit that receives a data signal input from another device and data receiving method thereof.

### BACKGROUND ART

In receiving data with the use of a currently standardized serial interface, such as USB2.0, Serial ATA, or the like, the data is received only after input of the data is detected (see Non-patent Document 1 and Non-patent Document 2). This is because: with the use of a cable or the like for data transmission to and from another device, timing of data transmission cannot be determined well.

Recently, minimization of voltage amplitude of data, which progresses in association with an increase in speed of data transmission, necessitates determining whether an input signal is a data signal or a noise signal. Further, future increase in speed of data transmission will increase necessity of necessitate technique for noise discrimination. For this reason, a method of detecting input of an input signal is being increased in accuracy and functions (see Patent Document 1, for example).

FIG. 9(a) shows a basic configuration of a conventional data receiving circuit. As shown in FIG. 9(a), the data receiving circuit 500 includes a signal detector 501 and a signal receiver 502

Upon input of an input signal (DATA) to the data receiving circuit 500, the signal detector 501 first detects input of the input signal (DATA) and outputs, on the basis of the detection information, a start signal 50A for activating the signal receiver 502. The signal receiver 502 that has received the start signal 50A is activated to start receiving the input signal (DATA). The thus received input signal (DATA) is output as an output signal 50B to an internal circuit.

FIG. 9(b) is a timing chart showing operation of the data receiving circuit 500. Recently, as shown in FIG. 9(b), the amplitudes of the input signals becomes smaller as the speed of data transmission is increased, and therefore, whether each input signal is a data signal or a noise signal must be determined. For this reason, the signal detector 501 performs discrimination between data and noise in addition to detection of the amplitude size of each input signal and the length of each data.

Patent Document 1: Japanese Patent Application Laid Open Publication No. 2000-196464 Non-patent Document 1: USB Revision 2.0 Specification, “Universal Serial Bus Specification,” retrieved on Oct. 14, 2004 in Internet (URL: http://www.usb.org/developers/docs/usb#20.zip, which is unzipped to “ . . . /USB#20/USB#20.pdf,” page 140

Non-patent Document 2: Serial ATA Specification retrieved on Oct. 14, 2004 in Internet (URL:http://www.sata-io.org/docs/PHYii%20Spec%20Rev%201#0%20052604.pdf, pp. 30-32

### SUMMARY OF THE INVENTION

### Problems that the Invention is to Solve

Detection of signal input in the signal detector requires time to thus disable data acquisition during the detection, so that the amount of missing data at a leading part of the input data increases. Further, in the case where data transmission is performed via a repeater, such as HUB or the like, such data missing occurs every time when data output from a data source passes through the repeater, making such adverse influence more serious.

The present invention has been made in view of the foregoing and has its object of suppressing data missing in receiving an input signal.

### Means for Solving the Problems

To attain the above object, in the present invention: input of an input signal is detected: whether the input signal is a data signal or a noise signal is determined; data receipt starts on the basis of the detection information; and when the input signal is determined as a data signal, the thus received input signal is output as a data signal.

Specifically, the present invention provides a data receiving device including a signal detector which detects an input state of an input signal and a signal receiver which receives the input signal, wherein the signal detector includes determination means for determining whether the input signal is a data signal or a noise signal, and the signal receiver includes: a receiving circuit which starts receiving the input signal when input of the input signal is detected in the signal detector; and a first logic circuit which outputs as a data signal a receiving signal received at the receiving circuit when the input signal is determined as a data signal in the signal detector.

Further, the present invention provides a data receiving method including the steps of: detecting an input state of an input signal; starting receiving the input signal when input of the input signal is detected; determining whether the input signal is a data signal or a noise signal; and outputting the received receiving signal as a data signal when the input signal is determined as a data signal.

### EFFECTS OF THE INVENTION

As described above, according to the present invention, even though it takes time to determine an input signal as a data signal or a noise signal, missing of a top part of data can be suppressed to a minimum by utilizing each delay time of the receiving circuit and the logic circuit.

### BRIEF DESCRIPTION OF THE DRAWINGS

FIG. 1 is a diagram showing a configuration of data receiving device in accordance with Embodiment 1 of the present invention.

FIG. 2 is a diagram showing a configuration of a signal detector in accordance with Embodiment 1.

FIG. 3 is a diagram showing a configuration of a filter circuit in accordance with Embodiment 1.

FIG. 4 is a diagram showing a configuration of a first logic circuit in accordance with Embodiment 1.

FIG. 5 is a diagram showing a configuration of a signal detector in accordance with Embodiment 2.

FIG. 6 is a diagram showing a configuration of a signal detector in accordance with Embodiment 3.

FIG. 7 is a truth table for a second logic circuit in accordance with Embodiment 3.

FIG. 8 is a diagram showing a configuration of a first logic circuit in accordance with Embodiment 4.

FIG. 9(a) is a diagram showing a configuration of a conventional data receiving device, FIG. 9(b) is a timing chart showing operation of the conventional data receiving device, and FIG. 9(c) is a timing chart in the case where it take time for the conventional data receiving device to detect signal input.

### EXPLANATION OF REFERENCE NUMERALS

100 data receiving circuit
101 signal detector
102 signal receiver
103 receiving circuit
104 first logic circuit
110 first offset comparator
111 second offset comparator
113 first filter circuit
114 second filter circuit
125 counter
135 second logic circuit
140 delay circuit
150 clock data recovery circuit (CDR circuit)
151 shift resistor

### BEST MODE FOR CARRYING OUT THE INVENTION

Embodiments of the present invention will be described below with reference to the accompanying drawings. The following preferred embodiments are substantially mere examples and are not intended to limit the present invention and applicable objects and usage thereof.

### EMBODIMENT 1

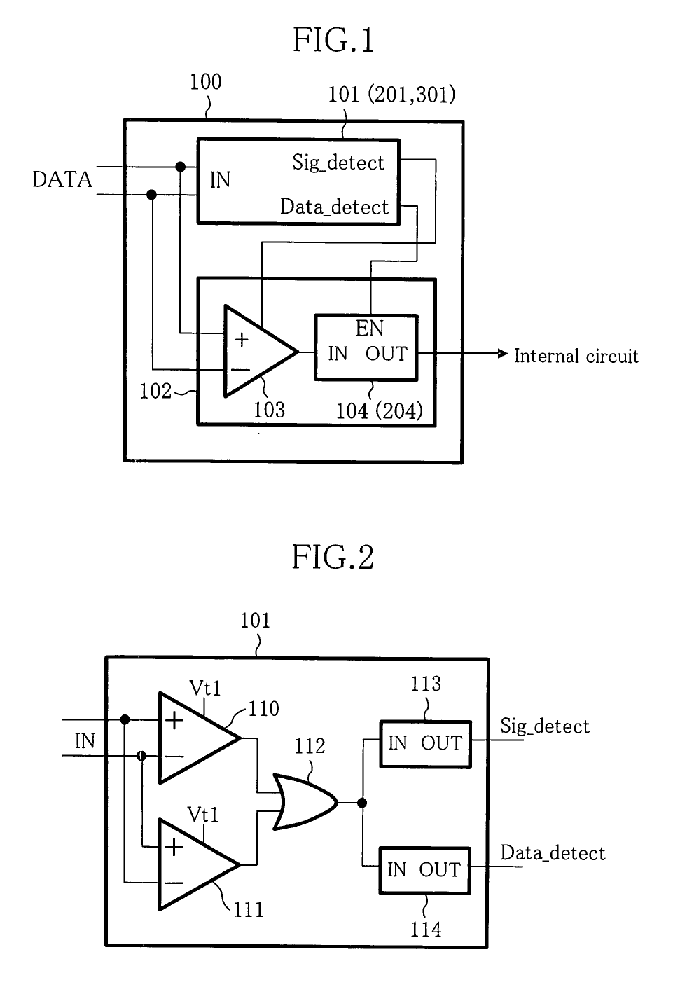

FIG. 1 is a diagram showing a configuration of a data receiving device 100 in Embodiment 1 of the present invention. As shown in FIG. 1, the data receiving device 100 includes a signal detector 101 which detects an input state of an input signal and determines whether the input signal is a data signal or a noise signal and a signal receiver 102 which receives the input signal and controls output thereof.

The signal detector 101 includes an input terminal IN which inputs a signal; an output terminal Sig_detect which outputs, on the basis of detection information of the input signal, a start signal that activates the signal receiver 102; and an output terminal Data_detect which outputs a determination result indicating whether the input signal is a data signal or a noise signal.

The signal receiver 102 includes a receiving circuit 103 that starts receiving the input signal upon receipt of the start signal output from the signal detector 101 and a first logic circuit 104 that controls output of an output signal on the basis of the determination result indicating whether the input signal is a data signal or a noise signal. The internal configurations of the signal detector 101 and the first logic circuit 104 will be described later.

Operation of the thus configured data receiving device 100 in accordance with Embodiment 1 will be described next. When the data receiving device 100 receives an input signal, the signal detector 101 detects the input state thereof and outputs a start signal for activating the signal receiver 102 from the output terminal Sig_detect on the basis of the detection information. Further, the signal detector 101 determines whether the input signal is a data signal or a noise signal and outputs the determination result from the output terminal Data_detect.

Upon receipt of the start signal, the receiving circuit 103 of the signal receiver 102 starts receiving the input signal. As well, the first logic circuit 104 receives the determination result and controls output of an output signal on the basis of the determination result. Specifically, when the input signal is determined as a data signal, the data signal is output as an output signal from the first logic signal 104. Otherwise, namely, when it is determined as a noise signal, output of the output signal is halted.

The data receiving circuit 100 utilizes delay times of the receiving circuit 103 and the first logic circuit 104 for determination as to whether the input signal is a data signal or a noise signal.

FIG. 2 is a diagram showing an internal configuration of the signal detector 101 in accordance with Embodiment 1. The signal detector 101 detects signal input when the input signal input to the input terminal IN has an amplitude equal to or larger than Vt1 and determines whether the input signal is a data signal or a noise signal according to whether or not a state is detected in which the input signal is being input continuously for a predetermined period.

When the input signal is input to the signal detector 101, a first offset comparator 110 senses the size of the positive amplitude of the input signal while a second offset comparator 111 senses the size of the negative amplitude of the input signal.

Sensing results that the first and second offset comparators 110, 111 sense are input to an OR circuit 112, are filtered in first and second filter circuits 113, 114, respectively, and then are output as the start signal and the determination result. The time constants for filtering in the first and second filter circuits 113, 114 are changed so as to obtain desired outputs.

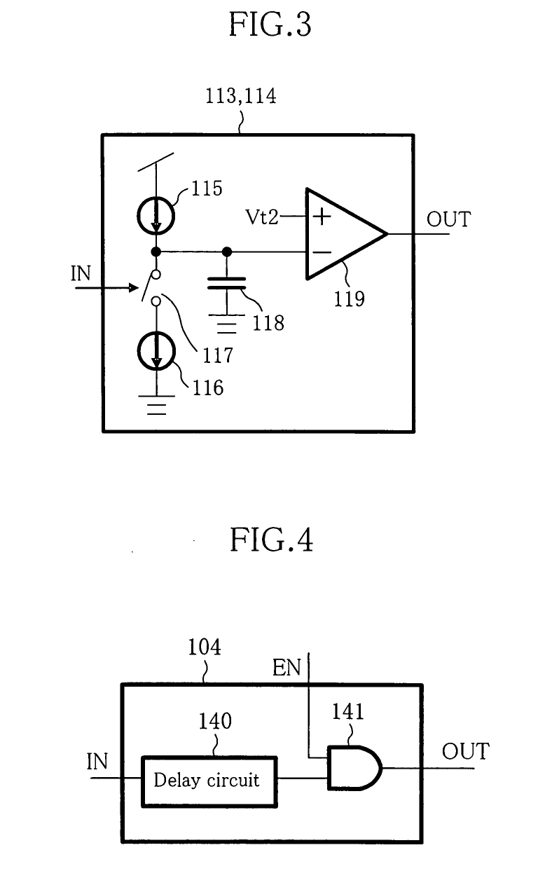

FIG. 3 is a diagram showing a configuration of the first or second filter circuit 113 or 114. As shown in FIG. 3, each of the first and second filter circuits 113, 114 includes first and second current sources 115, 116 as current sources, a switch 117, a capacitor 118 as a condenser, and a comparator 119.

Upon input of the signal to each of the first and second filter circuits 113, 114 from the OR circuit 112, the switch 117 is turned on to allow the capacitor 118 to discharge charges so that the comparator 119 senses a potential varied according to the amount of the discharged charges and the capacity of the capacitor 118.

Change in flow rate of the second current source 116 or in capacity of the capacitor 118 changes a time constant. Specifically, in the first filter circuit 113, the flow rate of the second current source 116 is set large for reducing time required from input detection of the input signal to output of the detection result. It is noted that the same effects can be obtained even when the second current source 116 is removed for terminal contraction thereof.

It is also noted that the comparator 119 provided for comparing the input voltage is not limited to the aforementioned type and may be replaced by an inverter, for example.

FIG. 4 is a diagram showing a configuration of the first logic circuit 104. In the first logic circuit 104, the signal received at the receiving circuit 103 is input to a delay circuit 140 through an IN terminal thereof while a determination result indicating whether the input signal is a data signal or a noise signal is input through an AND circuit 141 from an EN terminal thereof.

The delay circuit 140 performs control so that input timing that the signal received at the receiving circuit 103 is input is adjusted and then the thus received signal is output to the AND circuit 141.

Specifically, in the case where it takes time to determine whether the input signal is a data signal or a noise signal and input of the determination result to the AND circuit 141 is hung on, the delay amount of the delay circuit 40 is set large to delay the input timing of the signal received at the receiving circuit 103. In the case where the delay at the receiving circuit 103 is sufficient with no further delay necessitated, the delay circuit 140 is omitted.

It is noted that the delay circuit 140 may be replaced by a circuit having another function, such as pattern matching, synchronization of a receiving signal with the internal clock, or the like to utilize delay thereof.

When the input signal is determined as a data signal, the AND circuit 141 outputs, on the basis of the determination result output from the signal detector 101, the data signal received at the receiving circuit 103 as an output signal. Otherwise, namely, when it is determined as a noise signal, output of the output signal is halted.

Though the data receiving device of Embodiment 1 presumes that the receiving signal in data transmission under USB2.0 or Serial ATA is a serial differential signal, the present invention is not limited thereto. The same is applied to Embodiments 2 to 4 described below.

### EMBODIMENT 2

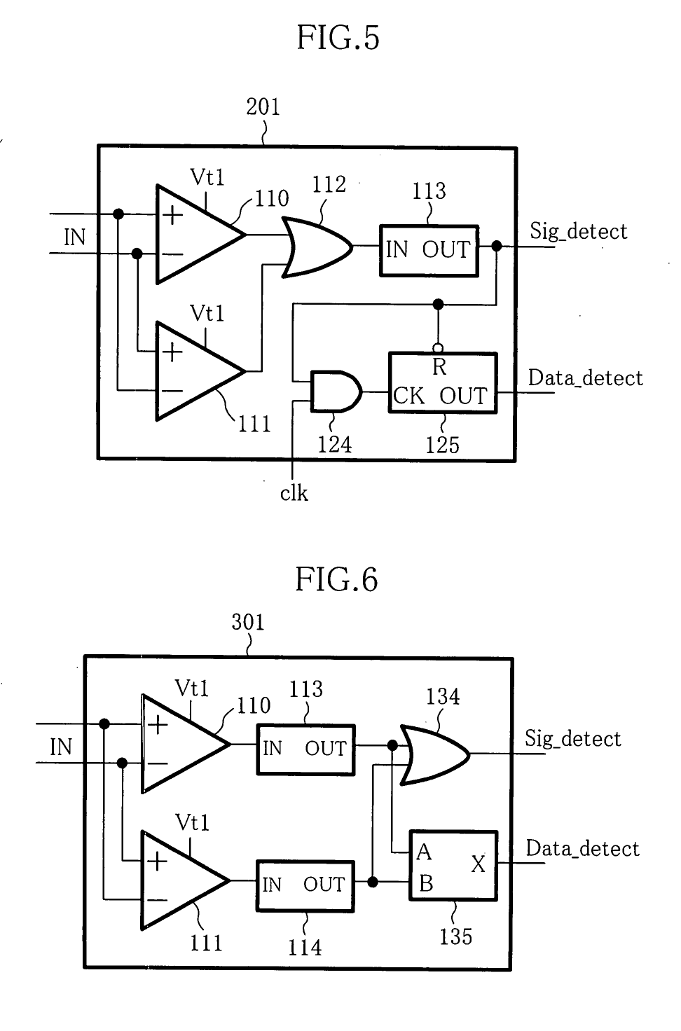

FIG. 5 is a diagram showing a configuration of a signal detector 201 of a data receiving device in accordance with Embodiment 2 of the present invention. The data receiving device of the present embodiment is the same as Embodiment 1 as a whole and is different only in circuit configuration of the signal detector 201 from Embodiment 1. Therefore, the same reference numerals are assigned to the same elements as those in Embodiment 1, and only the difference will be described (the same is applied to Embodiment 3).

When an input signal is input to the signal detector 201, the first offset comparator 110 senses the size of the positive amplitude of the input signal while the second offset comparator 111 senses the size of the negative amplitude of the input signal.

Sensing results sensed in the first and second offset comparators 110, 111 are input to the OR circuit 112 and is filtered in the first filter circuit 113, and then, an output signal thereof is output as the start signal from the output terminal Sig_detect while being input to an AND circuit 124 and a counter 125.

The AND circuit 124 receives the filtered signal and a CLK signal and inputs a resultant output thereof to the counter 125. The counter 125 exactly measures, on the basis of the filtered signal and the resultant output from the AND circuit 124, a time period when the input signal has an amplitude larger than Vt1. The input signal is determined as a data signal or a noise signal on the basis of the measurement result, and a determination result is output from the output terminal Data_detect.

### EMBODIMENT 3

FIG. 6 is a diagram showing a configuration of a signal detector 301 of a data receiving device in accordance with Embodiment 3 of the present invention. When an input signal is input to the signal detector 301, the first offset comparator 110 senses the size of the positive amplitude of the input signal while the second offset comparator 111 senses the size of the negative amplitude of the input signal.

A sensing result sensed in the first offset comparator 110 is input to the first filter circuit 113 to be filtered. The thus filtered signal is input to an OR circuit 134 and a second logic circuit 135.

On the other hand, a sensing result sensed in the second offset comparator 111 is input to the second filter circuit 114 to be filtered. The thus filtered signal is input to the OR circuit 134 and the second logic circuit 135.

The OR circuit 134 performs input detection of the input signal on the basis of the signals input from the first and the second filter circuits 113, 114 and outputs the start signal from the output terminal Sig_dtect.

The second logic circuit 135 determines whether the input signal is a data signal or a noise signal on the basis of the signals input from the first and second filter circuit 113, 114.

Specifically, the data determination is performed by judging whether state transition of the input signal occurs within a predetermined time period. The state transition means transition from a “High” state that the input signal has a large positive amplitude to a “Low” state that it has a large negative amplitude or from the “Low” state to the “High” state.

During the time when the above state transition occurs, the signals filtered by the filter circuits 113, 114 have large amplitude. Accordingly, the second logic circuit 125 detects the filtered signals to sense the state transition between “Low” and “High.”

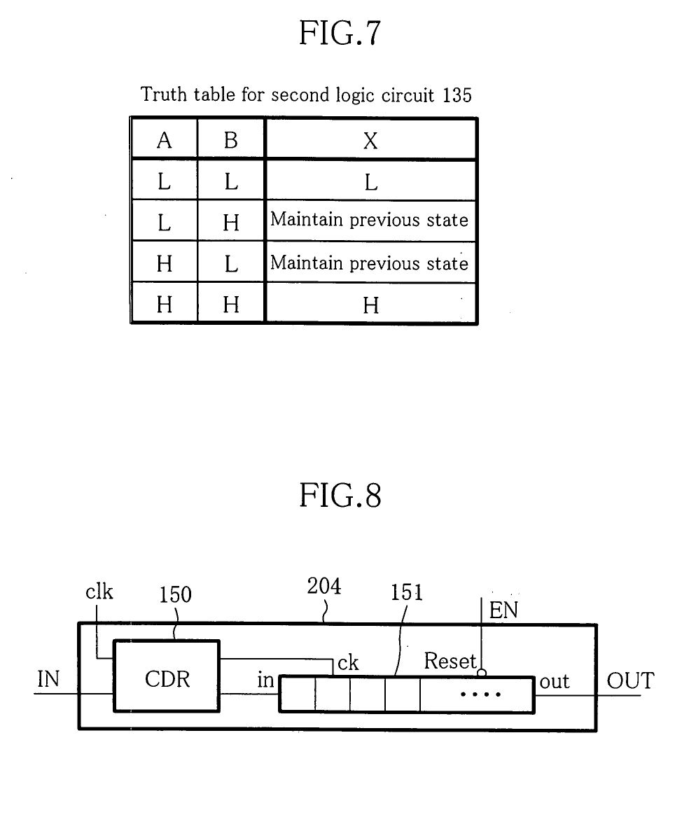

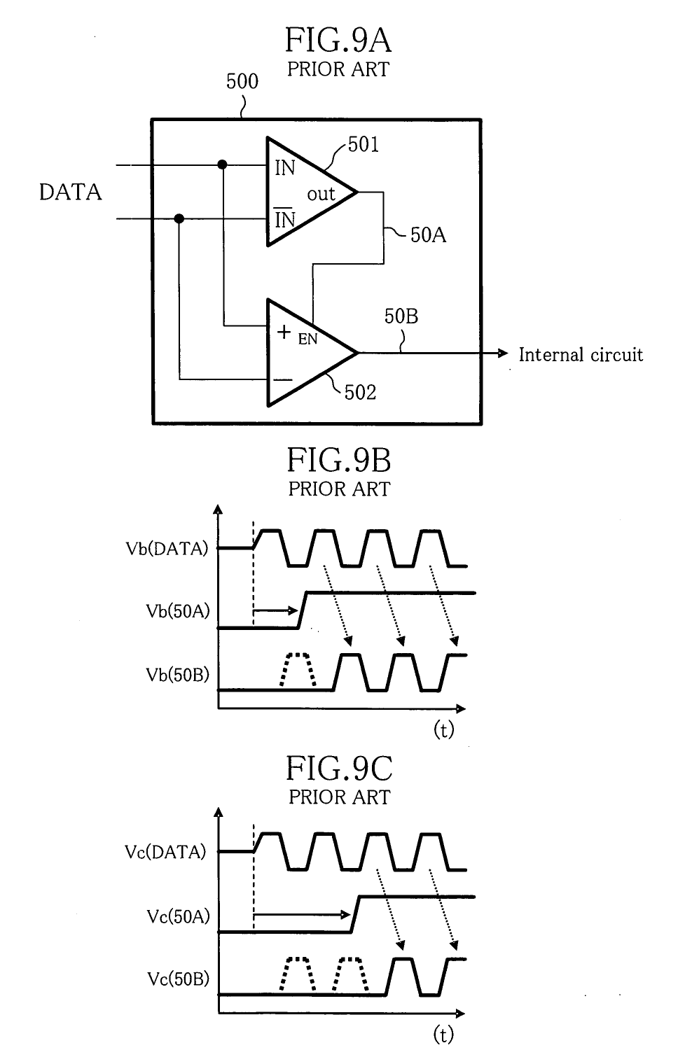

FIG. 7 shows a truth table for the second logic circuit 135. In this table, H and L indicate detection and no detection of an input signal having large amplitude, respectively, at input A or B. The second logic circuit 135 outputs, to an output terminal X, H when the state transition is detected or L when the input signal is in neither the “High” state nor the “Low” state (no signal is input).

### EMBODIMENT 4

FIG. 8 shows a diagram showing a configuration of a first logic circuit 204 of a data receiving circuit in accordance with Embodiment 4 of the present invention. The difference from Embodiment 1 lies only in the circuit configuration of the first logic circuit 204. Therefore, the same reference numerals are assigned to the same elements as those in Embodiment 1, and only the difference will be described below.

The first logic circuit 204 includes a clock data recovery circuit 150 (hereinafter referred to it as a CDR circuit) which synchronizes a receiving signal with an internal clock and a shift resistor 151.

The CDR circuit 150 receives the input signal received at the receiving circuit 103. Upon receipt of a CLK signal from outside, the CDR circuit 150 inputs the input signal held in the receiving circuit 103 to the shift resistor 151.

The shift resistor 151 receives from an EN terminal thereof the determination result indicating whether the input signal is a data signal or a noise signal. When the input signal is determined as a noise signal, the shift resistor 151 is reset. Otherwise, namely, it is determined as a data signal, the reset state is released so that the shift resistor 151 outputs the data signal as an output signal.

Though the CDR circuit 150 is inserted in the first logic circuit 204 for adjusting timing between data and a clock input to the shift resistor 151, the CDR circuit 150 may be omitted if the timing adjustment is unnecessary. The shift resistor 151 may be replaced by another data storage circuit, of course.

As described above, the data receiving device with the clock in accordance with Embodiment 4 guarantees the hold time of a receiving signal further exactly and is, therefore, useful especially in the case where it is complicated and takes time to determine whether a signal is data or noise in the signal detector 101.

### INDUSTRIAL APPLICABILITY

As described above, the data receiving device in accordance with the present invention suppresses data missing of a leading part of a data signal to a minimum. Further, receipt of an input signal is performed in parallel with determination as to whether the input signal is a data signal or a noise signal, so that the time period from input to output of the input signal can be reduced when compared with serial processing where determination as to whether the input signal is a data signal or a noise signal is performed only after the input signal is received. Accordingly, this effect is much practical, and therefore, the present invention is useful and has significant industrial applicability.

1. A data receiving device, comprising a signal detector which detects an input state of an input signal and a signal receiver which receives the input signal,
wherein the signal detector includes determination means for determining whether the input signal is a data signal or a noise signal, and
the signal receiver includes:
a receiving circuit which starts receiving the input signal when input of the input signal is detected in the signal detector; and
a first logic circuit which outputs as a data signal a receiving signal received at the receiving circuit when the input signal is determined as a data signal in the signal detector.

2. The data receiving device of claim 1,
wherein the determination means includes:
an offset comparator which detects input of the input signal on the basis of amplitude size of the input signal; and
a counter which measures a time period when the input signal input has an amplitude equal to or larger than a predetermined value.

3. The data receiving device of claim 1,
wherein the determination means includes:
an offset comparator which detects input of the input signal on the basis of amplitude size of the input signal; and
a second logic circuit which detects that the input signal is in a transition state from positive amplitude to negative amplitude or from negative amplitude to positive amplitude within a predetermined time period.

4. The data receiving device of claim 1,
wherein the first logic circuit includes a delay circuit which delays a receiving signal input from the receiving circuit.

5. The data receiving device of claim 1,
wherein the first logic circuit includes a clock data recovery circuit which synchronizes a receiving signal input from the receiver with an internal clock.

6. The data receiving device of claim 5,
wherein the first logic circuit includes a shift resistor which receives a receiving signal phase-adjusted in the clock data recovery circuit and of which reset state is released when the input signal is determined as a data signal in the signal detector.

7. The data receiving device of claim 1,
wherein the first logic circuit includes a storage circuit which stores a receiving signal input from the receiving circuit.

8. A data receiving method comprising the steps of:
detecting an input state of an input signal;
starting receiving the input signal when input of the input signal is detected;
determining whether the input signal is a data signal or a noise signal; and
outputting the received receiving signal as a data signal when the input signal is determined as a data signal.

9. A data receiving method comprising the steps of:
detecting input of an input signal on the basis of amplitude size of the input signal;
starting receiving the input signal when input of the input signal is detected;
measuring a time period when the input signal input has an amplitude equal to or larger than a predetermined value to determine on the basis of a measurement result whether the input signal is a data signal or a noise signal; and
outputting the received receiving signal as a data signal when the input signal is determined as a data signal.

10. A data receiving method comprising the steps of:
detecting input of an input signal on the basis of amplitude size of the input signal;
starting receiving the input signal when input of the input signal is detected;
detecting transition of the input signal from positive amplitude to negative amplitude or from negative amplitude to positive amplitude within a predetermined time period to determine on the basis of a detection result whether the input signal is a data signal or a noise signal; and
outputting the received receiving signal as a data signal when the input signal is determined as a data signal.

11. A data receiving method comprising the steps of:
detecting an input state of an input signal;
starting receiving the input signal when input of the input signal is detected;
storing temporally the received receiving signal;
determining whether the input signal is a data signal or a noise signal; and
outputting the stored receiving signal as a data signal when the input signal is determined as a data signal.
